(19) United States
(12) Patent Application Publication
(10) Pub. No.: US 2023/0192457 A1
(43) Pub. Date: Jun. 22, 2023

(54) MULTI-WINCH HOISTING SYSTEM AND METHOD FOR COMBINING MULTIPLE-WINCHES IN A HOISTING SYSTEM

(71) Applicant: National Oilwell Varco Norway AS, Kristiansand S (NO)

(72) Inventor: Frank Tønnessen, Grimstad (NO)

(73) Assignee: National Oilwell Varco Norway AS, Kristiansand S (NO)

(21) Appl. No.: 17/989,874

(22) Filed: Nov. 18, 2022

(30) Foreign Application Priority Data
Dec. 16, 2021 (EP) 21215109.6
Nov. 8, 2022 (EP) 22206050.1

(51) Int. Cl. B66C 23/18; F16M 13/02; B66D 1/26; F16G 11/00

(52) U.S. Cl. CPC B66C 23/18; B66D 1/26; F16G 11/00; F16M 13/02

(57) ABSTRACT

A hoisting system for hoisting a load includes: i) a main winch system having a main rope with an end connector mounted to an end of the main rope, ii) an auxiliary winch system having an auxiliary rope having at least one rope connector of which at least one is a splitable rope connector, the auxiliary rope comprising a first section and a second section connected to the first section via the splitable rope connector, wherein the splitable rope connector comprises at least two connector parts that are releasably connected with each other for allowing quick disconnection and reconnection between the second section and the first section, wherein the connector parts (are configured for releasably connecting with the end connector of the main rope, and iii) a hang-off point placed and configured for at least temporarily holding a respective rope connector of the auxiliary rope for transferring the load to the hang-off point. The system may include two auxiliary winch systems.

### CROSS-REFERENCE TO RELATED APPLICATIONS

This application claims priority to European Application No. 21215109.6 filed Dec. 16, 2021 and European Application No. 22206050.1 filed Nov. 8, 2022, each of which is hereby incorporated herein by reference in its entirety for all purposes.

### STATEMENT REGARDING FEDERALLY SPONSORED RESEARCH OR DEVELOPMENT

Not applicable.

### FIELD OF THE INVENTION

The present disclosure relates to a hoisting system for hoisting a load comprising a main winch system and an auxiliary winch system. The present disclosure further relates to a method of hoisting a load using such hoisting system.

### BACKGROUND

Rope extension systems are known. WO2010/093251A1, owned by the same applicant as the current patent application, discloses a method and a device for hoisting an item at sea with a hoisting device comprises moving the item between a plurality of different height levels. In addition, the method comprises alternately supporting the load of the item with a first hoisting rope and a second hoisting rope while moving the item between the plurality of different height levels. Further, the method comprises arranging the first hoisting rope and the second hoisting rope to extend in parallel along at least part of the distance between the item and the hoisting device. Still further, the method comprises releasably connecting the first hoisting rope to the second hoisting rope. Moreover, the method comprises suspending the second hoisting rope from a hanger when the second hoisting rope is supporting the load of the item. The method also comprises connecting the hanger to an arm of the hoisting device. The second hoisting rope comprises a plurality of ball-shaped connectors along the longitudinal extent thereof, wherein the connectors are structured to fit into the hanger.

The applicant further developed the rope extension system and applied for a patent on this improvement. WO2020/130840A1, owned by the same applicant as the current patent application, discloses a rope extension system comprising a rope having at least two rope segments. Each rope segment has at least one prepared end comprising a rope eye. The rope extension system further comprises a rope connector, wherein the rope connector connects prepared ends of the at least two rope segments. The rope connector comprises at least two complementary parts, wherein each of said parts is configured with a shaped recess having a shape compliant with the rope eye for receiving at least part of the rope eye of said prepared end of a respective one of said rope segments, and wherein said parts are detachably mountable to each other to establish a firm connection there between that is strong enough to sustain the required tension capacity.

WO2020/130840A1 further discloses a hoisting system for hoisting a load, the hoisting system comprising the earlier-mentioned rope extension system. An example of such hoisting system further comprises a main hoisting system having a main hoisting rope. The rope extension system is configured for extending the main hoisting rope with the rope. The rope extension system further comprises a releasable lock mounted at the end of the main hoisting rope for gripping a respective connector on the rope for transferring the load to the main hoisting rope by lifting the releasable lock. The rope extension system further comprises a further lock provided on the hoisting system for selectively gripping another respective connector on the rope for transferring the load to the rope by lowering the releasable lock.

### SUMMARY

The object of embodiments described herein is to remedy or to reduce at least one of the drawbacks of the prior art, or at least provide a useful alternative to prior art.

The object is achieved through features which are specified in the description below and in the claims that follow. Embodiments described herein are defined by the independent claims. The dependent claims define advantageous embodiments described herein.

In a first aspect, a hoisting system for hoisting a load comprises:
a main winch system having a main rope with an end connector mounted to an end of the main rope, wherein the main winch system is configured to both spool the main rope in and spool the main rope out;
an auxiliary winch system including an auxiliary rope having at least one rope connector of which at least one is a splitable rope connector, wherein the auxiliary rope comprises a first section and a second section connected to the first section via the splitable rope connector, wherein the second section is configured to be spooled out first when the auxiliary winch system is spooled out, wherein the splitable rope connector comprises at least two connector parts that are releasably connected with each other and configured for quick disconnection and reconnection between the second section and the first section, wherein the connector parts are configured for releasably connecting with the end connector of the main rope, wherein the auxiliary winch system is configured to both spool the auxiliary rope in and spool the auxiliary rope out while the load is being suspended from an end connector of the auxiliary rope, and
a hang-off point placed and configured for at least temporarily holding a respective rope connector of the auxiliary rope for transferring the load to the hang-off point thereby releasing the splitable rope connector for handling.

The effects of the features of the hoisting in accordance with embodiments described herein are as follows. First of all, one potential benefit is that the auxiliary winch system comprises sections that are quickly connectable and disconnectable. Second, the auxiliary rope comprises at least one rope connector of which at least one is a splitable rope connector. The splitable rope connector facilitates the mentioned connection and disconnection of the respective sections. Furthermore, another potential benefit is the hang-off point, which is placed and configured for at least temporarily holding a respective one of the at least one rope connector. This temporary hang-off releases the splitable rope connector for handling. A further potential benefit is that the connector parts are configured for releasably connecting with the end connector. It is this combination of features which renders it possible to effectively add the length of the second section of the auxiliary rope to the length of the main rope, i.e., the ropes are connected in series. Such extension of the reach of the hoisting system does not appear to have been reported before. As will be explained, the embodiments described herein may be repeated multiple times, thereby allowing for an even greater reach of the hoisting system.

In contrast with the embodiments described herein, EP3,568,348B1 also discloses a hoisting system having two winch systems. However, in that system, the reach of the hoisting is not increased because the winches remain always connected. The main purpose of the auxiliary winch system in the present disclosure is to take over the heave-compensation role, while the main winch system takes the hoisting role. In order to enable this functionality, the system requires a sheave at its far end, which renders the system very complex. In contrast, embodiments of hoisting systems described herein provide simplicity and modularity.

In order to facilitate understanding of embodiments described herein, one or more expressions are further defined hereinafter.

The term “winch” refers to a hoisting system that includes both the winch as well as possibly necessary crane booms and sheaves in order to control/manipulate the working point of the winch. A winch must be able to spool its rope in and out while the load is being suspended from an end connector of the rope. This applies both to the main winch and any auxiliary winch in embodiments described herein. This is to differentiate from another type of apparatus that may be referred to as “reel”, “drum”, or “spool”, and which is not capable of spooling with a load being suspended therefrom. Additional systems are required to make that possible with such devices. Another advantage of the winch is that it may be used for active-heave compensation.

The phrase “main winch system” refers to the main hoisting system, often typically a steel wire rope system, but it may also be a fibre rope system. In embodiments described herein, the main winch system comprises the winch that is wound out last when hoisting down and first when hoisting up.

The phrase “auxiliary winch system” refers to the auxiliary hoisting system, which extends the reach of the main hoisting system by adding a substantive part of the auxiliary rope, namely the second section, to the length of the main hoisting system. It should be appreciated that for embodiments described herein, the auxiliary winch system must be able to spool the auxiliary rope in and out while the load is being suspended from an end connector of the auxiliary rope. Another advantage of using a winch as auxiliary device is that it may be used for active-heave compensation.

It should be appreciated that even though the claims and the figures show the main winch system and the auxiliary winch system as separate systems, they may just as well be mounted on the same crane or different cranes and may be even standing on different vessels. The same inventive concept applies to both situations as the detailed description will further illustrated.

The phrase “main rope” refers to the rope on the main winch system. This may be a steel wire rope, but it could also be a fibre rope, or another material.

The phrase “auxiliary rope” refers to rope on the auxiliary winch system. This may be a fibre rope, but it could also be a steel wire rope, or another material.

The phrase “hang-off” point is to be interpreted broadly, because the number of variations that is possible is very large. The commonality between all these variations is that it concerns a mechanical part, which is either configured to releasably connect to the at least one rope connector (or the connector parts thereof in case it concerns the splitable rope connector) or to receive and hold such rope connector. The detailed description illustrates some advantageous of embodiments.

In an embodiment of the hoisting system in accordance with the principles described herein, the hang-off point is mounted on a fixed-point external to the winches. This first group of embodiments renders the system simple, because the hang-off point can be virtually mounted everywhere relative to the winches. It may be placed on the platform or vessel where the winches are placed, for example at a moonpool or an edge of the platform of the vessel. It may alterative be placed on one of the cranes. The principle remains the same as long as the hang-off point is not mounted such that it coincides with the working points of the winches.

In an embodiment of the hoisting system in accordance with the principles described herein, the hang-off point is embodied in the end connector of the main rope. This embodiment includes an embodiment, wherein the hang-off point coincides with the working point of the main winch system. Even though this embodiment renders some aspects a bit more complicated it still offers some other advantages, namely that the hang-off point automatically becomes movable. This will be explained in further detail in the detailed description of the figures.

In an embodiment of the hoisting system in accordance with the principles described herein, the hang-off point is movable between a first position for engagement with the at least one rope connector and a second position not engaging with the at least one rope connector. Whether the hang-off point is placed at the working point of the winches or outside therefore, this embodiment provides for further flexibility during the hoisting, namely that it renders it possible to move the hang-off point towards the auxiliary rope, or alternative away from the auxiliary rope, while it fully bears the load. This feature is particularly interesting when the auxiliary rope comprises multiple rope connectors along its length. The majority of these rope connectors may then pass the hang-off point, and the hang-off point is only moved towards the target rope connector when this one is within reach.

In an embodiment of the hoisting system in accordance with the principles described herein, the hang-off point has at least two modes including an engagement mode, wherein the at least one rope connector is blocked from going through, and a releasing mode wherein the at least one rope connector is let through. This feature achieves a similar effect as the previously discussed embodiment and is also particularly interesting when the auxiliary rope comprises multiple rope connectors along its length. The majority of these rope connectors may then pass the hang-off point, and the hang-off point is switched to engagement mode when the target rope connector is within reach. This embodiment is also referred to as the mode-selectable hang-off point.

In an embodiment of the hoisting system in accordance with the principles described herein, the second section of the auxiliary rope comprises at least one auxiliary rope connector for being connected to the hang-off point while the connector parts of the splitable rope connector are disconnected or reconnected. The advantage of this embodiment is that the auxiliary rope connector takes over the hang-off role from the splitable rope connector, such that it is released for handling. The detailed description will further illustrate this aspect.

In an embodiment of the hoisting system in accordance with the principles described herein, the auxiliary winch system comprises at least two compartments for allowing spooling of the second section onto one of said two compartments while the at least one rope connector and the first section are spooled onto another one of said at least two compartments. Rope connectors tend to render spooling on the winch more challenging, particularly in the case of multilayer winches. This embodiment conveniently allows for the rope connector to be spooled in a different compartment of the winch (a spooling guidance system may be required for that), whereas the largest part of the auxiliary rope is spooled onto the other compartment. This embodiment is particularly advantageous when the auxiliary rope has only one splitable rope connector or a splitable rope connector supplement with an auxiliary rope connector.

In an embodiment of the hoisting system in accordance with the principles described herein, the second section of the auxiliary rope comprises a plurality of rope connectors along its length. The applicant developed systems having auxiliary winch systems having an auxiliary rope with multiple rope segments having ends (such as spliced ends) that are connected in series by means of specially designed rope connectors. It must be stressed that even such auxiliary ropes can be used, but that these may require some more intelligence in the hang-off point as some of the other embodiments already presented, i.e., having movability and/or mode-selectability.

An embodiment of the hoisting system in accordance with the principles described herein, further comprises a further auxiliary winch system having a further auxiliary rope having a further end connector mounted to an end of the further auxiliary rope and at least one further rope connector of which at least one is a further splitable rope connector. The further auxiliary rope comprises a further first section and a further second section connected to the further first section via the further splitable rope connector. The further second section is spooled out first when the further auxiliary winch system is spooled out. The further splitable rope connector comprises at least two further connector parts that are releasably connected with each other for allowing quick disconnection and reconnection between the further second section and the further first section. The further auxiliary winch system is capable of both spooling the further auxiliary rope in and spooling the further auxiliary rope out.

This embodiment embodies the idea of repeating the same inventive thought in order to further extend the reach of the hoisting system. Instead of one auxiliary hoisting winch, two auxiliary hoisting winches are used. The further auxiliary winch system combines the end connector feature of the main winch system with the splitable rope connector feature of the auxiliary winch system.

The phrase “further auxiliary winch system” refers to a further hoisting system, which extends the reach of the main hoisting system further by further adding a substantive part of the further auxiliary rope, namely the further second section, to the length of the main hoisting system and the auxiliary hoisting system.

In a second aspect, embodiments described herein relate to a method for hoisting a load using a hoisting system in accordance with the principles described herein. The number of variations of hoisting systems in accordance with embodiments described herein is very large. Therefore, the methods as carried out by the various hoisting systems described herein are presented below in order to illustrate the essence of the invention.

In an embodiment of the method in accordance with the principles described herein, the method comprises:
suspending the auxiliary rope from the hang-off point by connecting a respective one of the at least one rope connector of the auxiliary rope with the hang-off point thereby releasing the splitable rope connector for handling, and
disconnecting said first section and second section of the auxiliary rope by disconnecting the connector parts and connecting the end connector of the main rope to the connector part of the second section, or disconnecting the end connector of the main rope from the connector part of the second section and reconnecting said first section and second section of the auxiliary rope by reconnecting the connector parts. These method activities constitute the core of the method of hoisting a load in accordance with the principles described herein. The first feature concerns the splitting of the rope connector of the auxiliary rope and the second feature concerns the suspending of the auxiliary rope from the hang-off point for releasing the splitable rope connector for handling. The third feature concerns the connecting of the end connector to the respective connector part of the second section.

In an embodiment of the method in accordance with the principles described herein, the method comprises:
suspending the load from the auxiliary rope;
hoisting down the load using the auxiliary winch system spooling out the auxiliary rope;
suspending the auxiliary rope from the hang-off point by connecting a respective one of the at least one rope connector of the auxiliary rope with the hang-off point thereby releasing the splitable rope connector for handling;
disconnecting the second section from the first section by disconnecting the connector parts of the splitable rope connector;
connecting the connector part that is connected to the second section to the end connector of the main rope, and
hoisting down the load using the main winch system spooling out the main rope. This embodiment of the method constitutes the hoisting down of the load using a main winch system and one auxiliary winch system.

In an embodiment of the method in accordance with the principles described herein, the method comprises:
suspending the load from the auxiliary rope that is connected to the main rope:
hoisting up the load using the main winch system spooling in the main rope;
suspending the auxiliary rope from the hang-off point by connecting a respective one of the at least one rope connector of the auxiliary rope with the hang-off point thereby releasing the splitable rope connector for handling;
disconnecting the main rope from the auxiliary rope by disconnecting the end connector of the main rope from the connector part that is connected to the second section;
connecting the connector part that is connected to the first section to the connector part connected to the second section, and
hoisting up the load using the auxiliary winch system spooling in the auxiliary rope. This embodiment of the method constitutes the hoisting up of the load using a main winch system and one auxiliary winch system.

In an embodiment of the method in accordance with the principles described herein, the method comprises:
suspending the load from the auxiliary rope;
hoisting down the load using the auxiliary winch system spooling out the auxiliary rope;
suspending the auxiliary rope from the hang-off point by connecting a respective one of the at least one rope connector of the auxiliary rope with the hang-off point thereby releasing the splitable rope connector for handling;
disconnecting the second section from the first section by disconnecting the connector parts of the splitable rope connector;
connecting the connector part that is connected to the second section to the further end connector of the further auxiliary rope;
hoisting down the load using the further auxiliary winch system spooling out the further auxiliary rope;
suspending the further auxiliary rope from the hang-off point by connecting a respective one of the at least one further rope connector of the further auxiliary rope with the hang-off point thereby releasing the further splitable rope connector for handling;
disconnecting the further second section from the further first section by disconnecting the further connector parts of the further splitable rope connector;
connecting the further connector part that is connected to the further second section to the end connector of the main rope, and
hoisting down the load using the main winch system spooling out the main rope. This embodiment of the method constitutes the hoisting down of the load using a main winch system and two auxiliary winch systems.

In an embodiment of the method in accordance with the principles described herein, the method comprises:
suspending the load from the auxiliary rope that is connected to the main rope via the further auxiliary rope;
hoisting up the load using the main winch system spooling in the main rope;
suspending the further auxiliary rope from the hang-off point by connecting a respective one of the at least one further rope connector of the further auxiliary rope with the hang-off point thereby releasing the further splitable rope connector for handling;
disconnecting the main rope from the further auxiliary rope by disconnecting the end connector of the main rope from the further connector part that is connected to the further second section;
connecting the further connector part that is connected to the further first section to the further connector part connected to the further second section, and
hoisting up the load using the further auxiliary winch system spooling in the further auxiliary rope;
suspending the auxiliary rope from the hang-off point by connecting a respective one of the at least one rope connector of the auxiliary rope with the hang-off point thereby releasing the splitable rope connector for handling;

disconnecting the further auxiliary rope from the auxiliary rope by disconnecting the further end connector of the further auxiliary rope from the connector part that is connected to the second section;
connecting the connector part that is connected to the first section to the connector part connected to the second section, and
hoisting up the load using the auxiliary winch system spooling in the auxiliary rope. This embodiment of the method constitutes the hoisting up of the load using a main winch system and two auxiliary winch systems.

### BRIEF DESCRIPTION OF THE DRAWINGS

In the following is described examples of embodiments illustrated in the accompanying figures, wherein:

FIG. 1 is a schematic view of a vessel comprising an embodiment of a hoisting system in accordance with principles described herein;

FIGS. 2a-2h are schematic views of different stages of an embodiment of a method of hoisting a load in accordance with the principles described herein and using an embodiment of the hoisting system in accordance with the principles described herein;

FIG. 3 is a perspective view of an embodiment of an auxiliary winch in accordance with the principles described herein, when fully spooled in;

FIG. 4 is a perspective view of an embodiment of the auxiliary winch of FIG. 3, when almost fully spooled out;

FIG. 5a illustrates a cross-sectional side view and a side view of an embodiment of a splitable rope connector in accordance with the principles described herein;

FIG. 5b is a schematic view of the splitable rope connector of FIG. 5a after having been spooled onto the auxiliary winch;

FIG. 6a illustrates a cross-sectional side view and a side view of another embodiment of a splitable rope connector in accordance with the principles described herein;

FIG. 6b is a schematic view of the splitable rope connector of FIG. 6a after having been spooled onto the auxiliary winch;

FIGS. 7a-7g schematically illustrate the interaction between the auxiliary rope connector and the hang-off point as well as how the connector parts of the splitable rope connector can be disconnected and subsequently connected with a first type of end connector;

FIGS. 8a-8d schematically illustrate the interaction between the auxiliary rope connector and the hang-off point as well as how the connector parts of the splitable rope connector can be disconnected and subsequently connected with a second type of end connector;

FIG. 9 is a schematic view of another embodiment of a method of hoisting a load in accordance with principles described herein and using another embodiment of the hoisting system in accordance with the principles described herein;

FIGS. 10a-10c illustrate schematic views of different stages of yet another embodiment of a method of hoisting a load in accordance with principles described herein and using yet another embodiment of the hoisting system in accordance with the principles described herein, and

FIGS. 11a-11b illustrate schematic views of different stages of yet another embodiment of a method of hoisting a load in accordance with principles described herein and using yet another embodiment of the hoisting system in accordance with the principles described herein.

### DETAILED DESCRIPTION

The known extension systems and hoisting systems function well but have still limitation as regards to its flexibility as regards extension capacity and reach. There is a need to further improve the system.

Traditional hoisting systems are using steel wire ropes as a load carrier. These systems have several challenges, such as weight of the rope, corrosion, and fatigue during active heave compensation (AHC). The main advantages of such systems are robustness, well-known technology, and decades of experience. The inventors of the present application have seen an increasing demand within subsea mining, geophysical surveys, and salvage operations to reach water depths of 6000 m or more. Future hoisting systems are more and more going in the direction of fiber ropes, replacing the traditional steel wire ropes. These ropes may be based on different materials or combination of these. Main advantages are light-weight (almost neutral in water), do not need grease (which can be washed out in deep waters), are not susceptible to corrosion, may allow for possible transfer of data signals through integrated cables, provide more accurate condition monitoring, and offer the possibility of replacing a damaged part of the rope by splicing. Disadvantages are rope size, high cost, temperature sensitivity, generally more fragile ropes, less experience from subsea load handling systems and need for larger bending radiuses hence larger sheaves and drums.

Various illustrative embodiments of the present subject matter are described below. In the interest of clarity, not all features of an actual implementation are described in this specification. It will of course be appreciated that in the development of any such actual embodiment, numerous implementation-specific decisions must be made to achieve the developers’ specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present subject matter will now be described with reference to the attached figures. Various systems, structures and devices are schematically depicted in the figures for purposes of explanation only and to not obscure the present disclosure with details that are well known to those skilled in the art. Nevertheless, the attached figures are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Embodiments described herein will be discussed in more detail with reference to the figures. The figures will be mainly discussed in as far as they differ from previous figures.

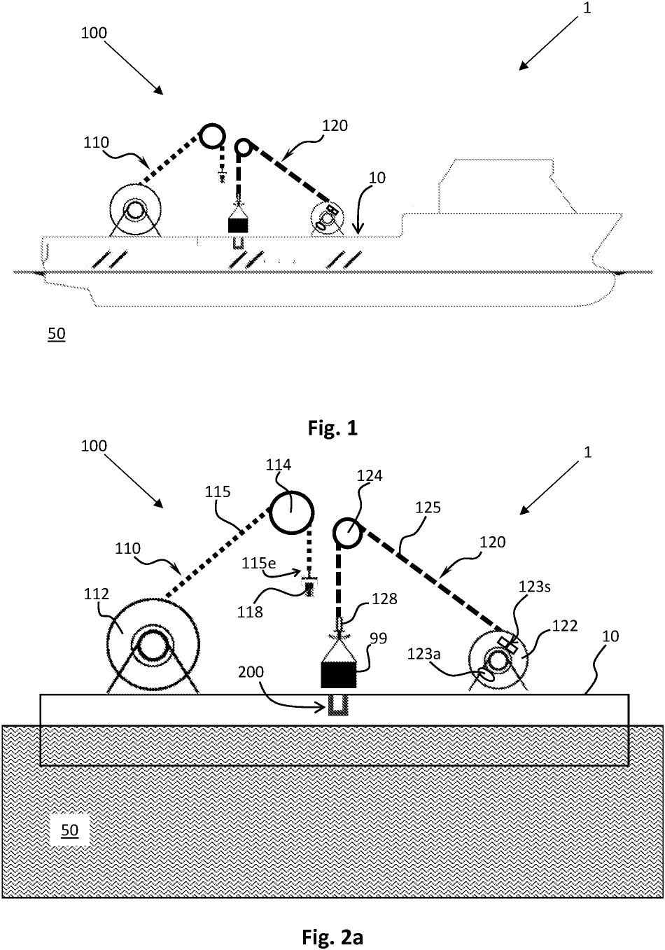

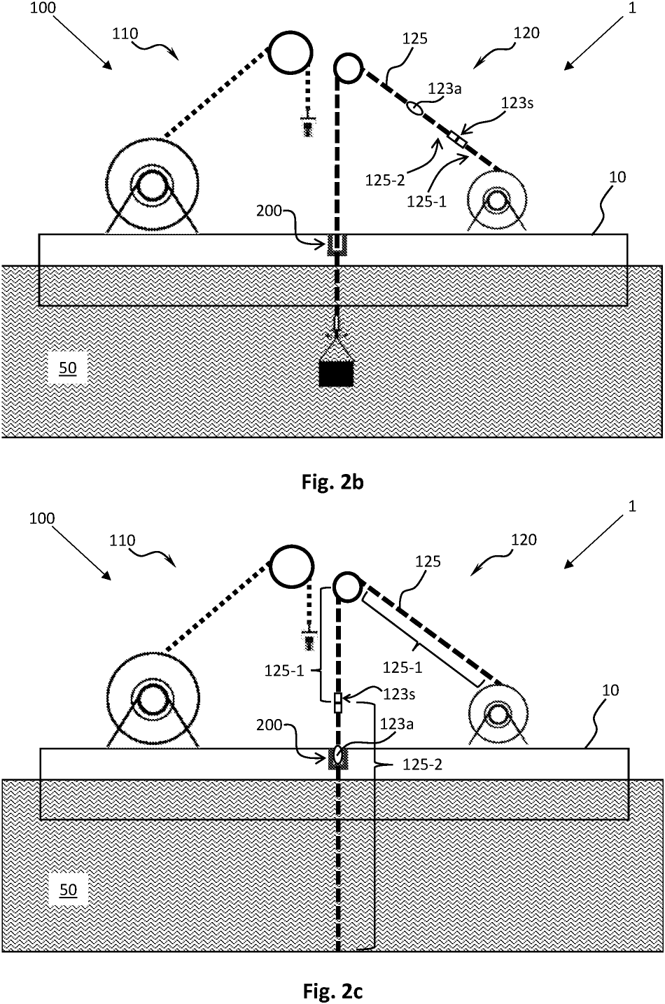

FIG. 1 shows a boat or vessel 1 comprising an embodiment of a hoisting system 100. The hoisting system 100 is placed on a deck 10 of the boat 1 floating in the sea 50 or other water. Even though the hoisting system 100 in the current example is placed on the deck 10 of a boat 1, in other embodiments, the hoisting system 100 may just as well be applied on a platform or any other floating vessel offshore, above the deck, on the deck or below the deck. In principle, the hoisting system may be also applied onshore, where its advantages are equally valid. In this embodiment, the hoisting system 100 comprises a main winch system 110 and an auxiliary winch system 120 as illustrated. As mentioned in the introduction, the winch systems may each be placed on a separate crane or on the same crane. Further details are discussed in view of FIG. 2a.

FIGS. 2a-2h illustrate different stages of a method of hoisting a load 99 using an embodiment of the hoisting system 100. Throughout the drawings the main winch system 110 is illustrated schematically by mainly showing a main winch 112, and a top sheave 114 guiding a main rope 115 as illustrated. Likewise, the auxiliary winch 120 is illustrated schematically by mainly showing an auxiliary winch 122, a top sheave 124, and an auxiliary rope 125 as illustrated. The main winch system 110 comprises an end connector 118 connected to an end 115e of the main rope 115. One special feature of the hoisting system 100 is the hang-off point 200, which in this embodiment is integrated in the deck 10 of the vessel 1.

In the stage shown in FIG. 2a, the load 99 is suspended from an end connector 128 of the auxiliary winch system 120. The auxiliary winch system 120 has some special features. A first feature is that the auxiliary rope 125 comprises a splitable rope connector 123s. A second, yet optional, feature is the auxiliary rope 125 comprises an auxiliary rope connector 123a, which does not need to be splitable. However, it will work with a splitable auxiliary rope connector 123a also.

In the stage shown in FIG. 2b, the load 99 is hoisted down by the auxiliary winch system 120 to such an extent that the rope connectors 123a, 123s have been spooled off and are now in the auxiliary rope 125. The splitable rope connector 123s is the essential rope connector and effectively divides the auxiliary rope 125 in two sections 125-1, 125-2. During the hoisting, the second section 125-2 (which is the outer section on the auxiliary winch that is spooled off first) is guided through the hang-off point 200 in this embodiment, i.e., the hang-off point 200 is designed such that the auxiliary rope 125 is let through.

In the stage shown in FIG. 2c, the load 99 is further hoisted down by the auxiliary winch system 120 to such an extent that the auxiliary rope connector 123a is received in the hang-off point 200. The figure now more clearly illustrates what is meant by the first section 125-1 and the second section 125-2 of the auxiliary rope 125. In FIGS. 2a-2h, the hang-off point 200 is passive and fixed in position. In other embodiments, the hang-off point 200 may not be a passive device that is fixed in location, but rather, may be a movable device, and then it would not be necessary to guide auxiliary rope through the hang-off point 200. Instead, the hang-off point 200 could then be moved towards the rope connector 123a, 123s for engagement therewith.

As an alternative solution, the hang-off point 200 may be designed such that it has at least two modes, one for engaging with the rope connectors and one for letting them through. Such embodiment as well as the previous movable embodiment have not been illustrated in detail as the person skilled in the art would be able to come up with numerous possible implementations for these functions.

As soon as the auxiliary rope connector 123a lands in (or is suspended from) the hang-off point 200, the tension in the first section 125-1 of the auxiliary rope 125 is reduced and the splitable rope connector 123s is released for handling by an operator. The auxiliary winch system 120 may be used to further lower the splitable rope connector 123s to the deck before the respective connector parts 123s1, 123s2 are disconnected.

In the stage shown in FIG. 2d, the respective connector parts 123s1, 123s2 are disconnected by an operator, that is an operator may come to disconnect the respective connector parts 123s1, 123s2 from each other. The auxiliary winch system 120 is then moved away from the hang-off point 200.

In case the auxiliary rope connector 123a is left out it is the splitable rope connector 123s that would have landed in (be suspended from) the hang-off point 200. An operator may still disconnect the respective connector parts 123s1, 123s2, but this may be a bit less easy to do as the splitable rope connector 123s may not be so easily reachable. In addition, this concerns slightly higher risk for the operator as well.

In the stage shown in FIG. 2e, the main winch system 110 is activated and the main rope 115 is hoisted down such that the end connector 118 has reached the second connector part 123s2 and has been connected to it as illustrated (may also be done by the same operator).

In the stage shown in FIG. 2f, the main winch system 110 is activated and the main rope 115 is hoisted up such that the load is transfer to the main winch system 110 and tension is built up in the main rope 115. Subsequently, the main winch system 110 lifts the auxiliary rope connector 123a out of the hang-off point 200 and then moves the working line to a position outside of the hang-off point 200 as illustrated. Subsequently, the load (not visible) is lowered. These movements are illustrated with the bend arrow M1 in FIG. 2f, which may also be referred to as the freeing movement of the rope assembly.

In the stage shown in FIG. 2g, the main winch system 110 is further activated and the main rope 115 is hoisted down further as illustrated by a further arrow M2 the downward movement.

In the stage shown in FIG. 2h, the main winch system 110 has lowered the load even further as illustrated by the further arrow M2. It can be observed from the sequence of steps in FIGS. 2a-2h that the hoisting system 100 conveniently adds the length of the second section 125-2 of the auxiliary rope 125 of the auxiliary winch system 120 to the length of the main rope 115 of the main winch system.

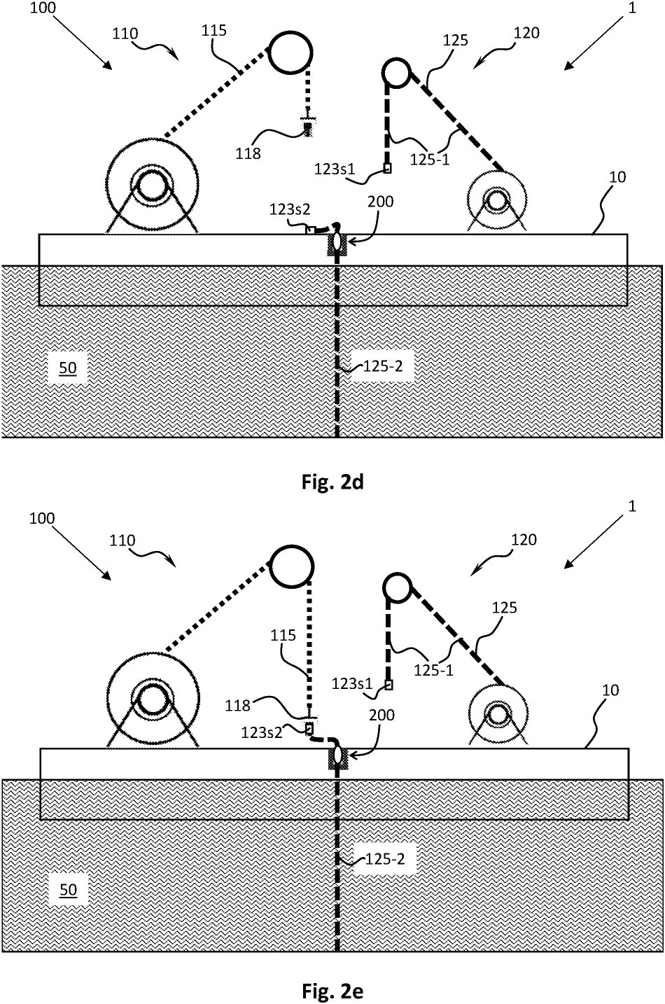

FIG. 3 shows an embodiment of the auxiliary winch 122 when fully spooled in. The auxiliary winch 122 comprises a winch drum 122d with the auxiliary wire 125 spooled on it and a spooling device 122s to facilitate the spooling as illustrated. The earlier mentioned rope connectors 123a, 123s disturb the regularity in the spooling and therefore the auxiliary winch 122 may be advantageously provided with a first compartment C1 for storing a major part of the second section 125-2 of the auxiliary rope 125 and a second compartment C2 for storing the first section 125-1 of the auxiliary rope 125 and the respective rope connectors 123a, 123s. The second section 125-2 is typically the longest. The benefit of multi-compartment winch drums is most significant for multilayer winches.

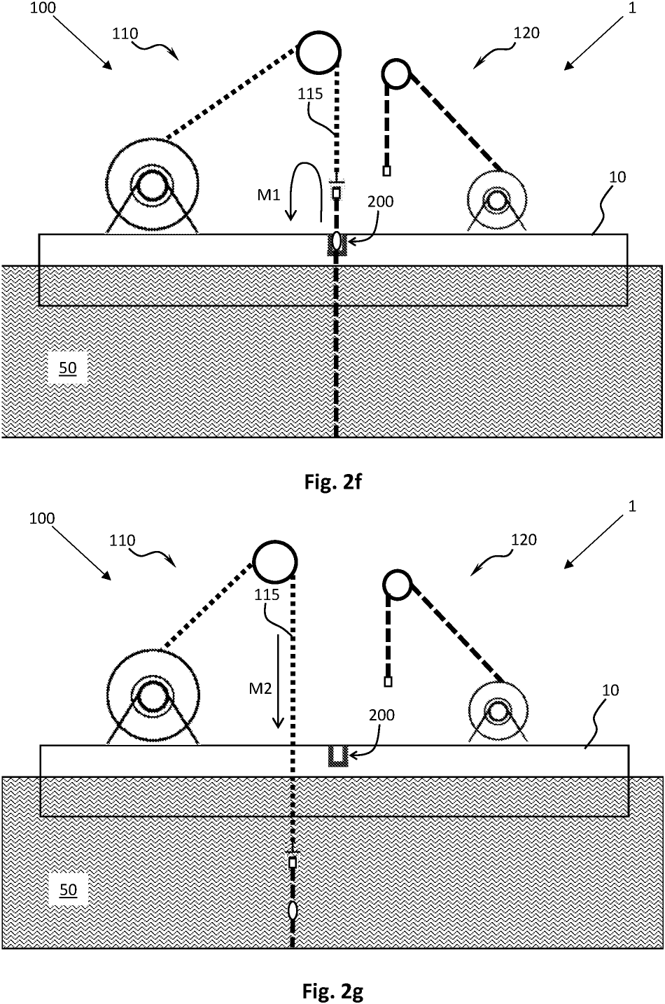

FIG. 4 shows an embodiment of the auxiliary winch 122 when almost fully spooled out. The first compartment C1 is now empty and the spooling device 122s has now moved to the second compartment C2 to facilitate spooling of the first section of the auxiliary rope 125. The compartments C1, C2 are separated by a wall having an opening as illustrated in order to enable the auxiliary rope 125 to run between said compartments C1, C2 smoothly.

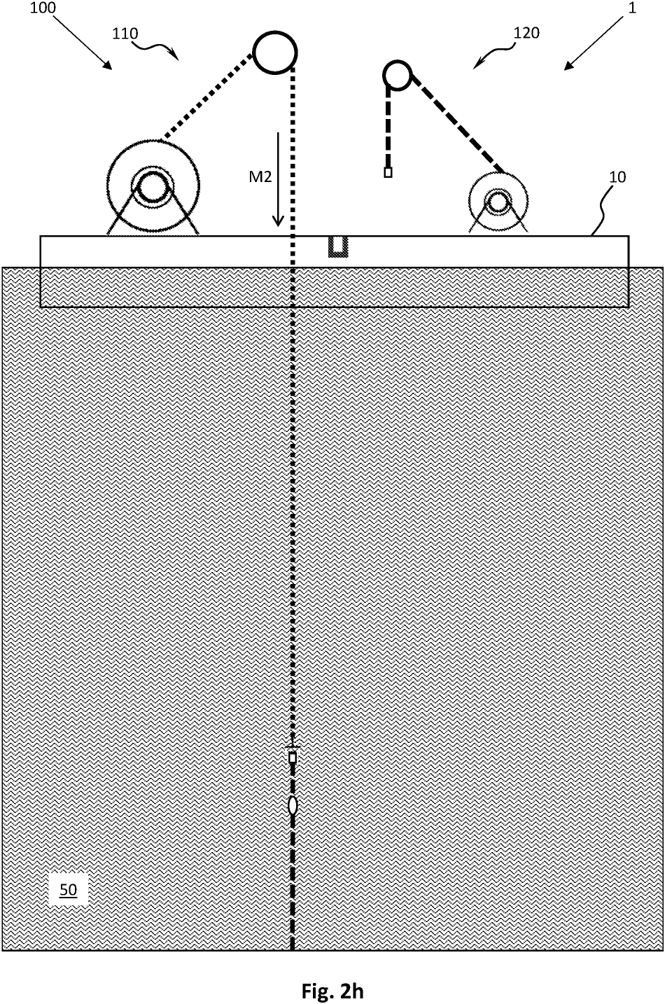

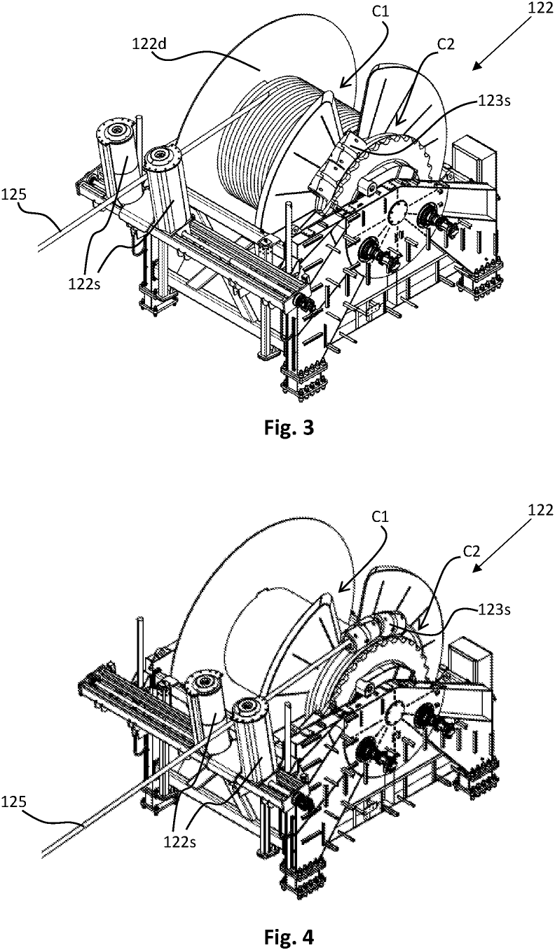

FIG. 5a shows an embodiment of a splitable rope connector 123s-2. The two drawings on the left side are orthogonal cross-sectional views. The two drawings on the right side are orthogonal side views. Both figures illustrated the respective sections 125-1, 125-2 of the auxiliary rope 125. The respective sections are terminated at spliced ends 125-1s, 125-2s as illustrated. The connector parts 123s1, 123s2 are shaped so as to receive these spliced ends 125-1s, 125-2s. Whereas in the previously illustrated embodiments the connector parts 123s1, 123s2 were releasably connected in a fixed manner, the present embodiment provides for a pivoting rotation degree-of-freedom between the parts 123s1, 123s2. This is achieved by implementing a hinge 123sh. The hinge 123sh comprises two ring extensions 123sr and a pin 123sp that pivotably connects the ring extensions 123sr together. The pin 123sp may be held in place with a locking member 123sl.

FIG. 5b shows the splitable rope connector 123s-2 of FIG. 5a after having been spooled onto the auxiliary winch 122. The figure schematically but clearly illustrates how the pivoting feature of the rope connector 123s-2 facilitates spooling around the auxiliary winch 122, particularly when the rope connector 123s-2 is relatively large compared to the winch 122. Disconnecting the connector parts 123s1, 123s2 in this embodiment requires the removal of the respective pin 123sp.

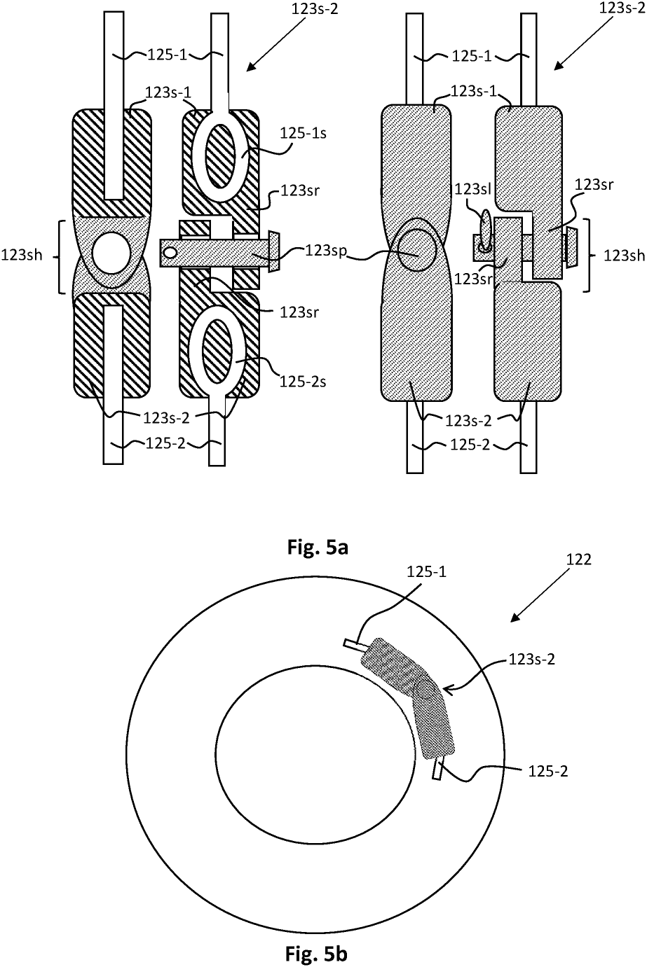

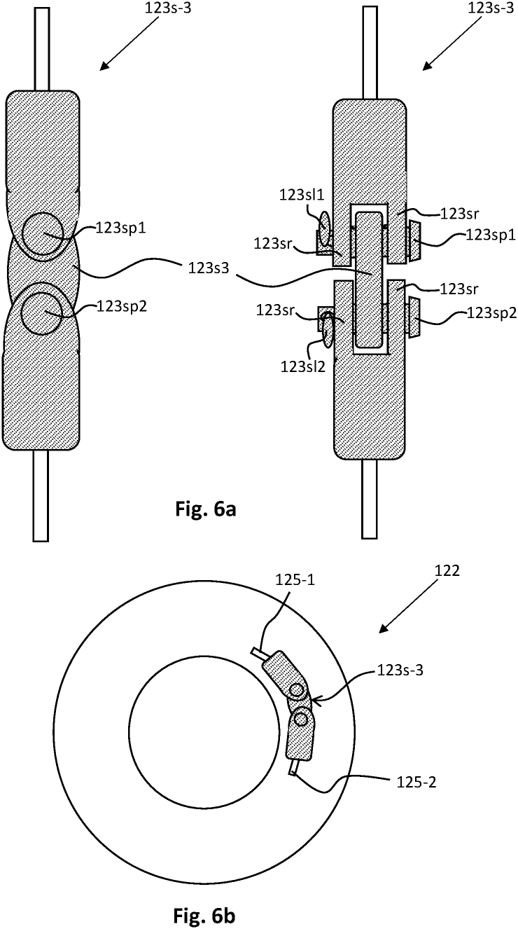

FIG. 6a shows another embodiment of a splitable rope connector 123s-3. This embodiment will be mainly discussed in as far as it differs from the embodiment in FIGS. 5a and 5b. A first difference is that the rope connector now comprises an intermediate connecting part 123s3 that is pivotably connected with both connecting parts 123s1, 1232 in a similar way as shown in FIGS. 5a and 5b and previously described. A further difference is that each connector part is provided with a double ring extension 123sr with the intermediate connector part 123s3 in between them. The intermediate connector part 123s3 has corresponding holes (not shown) through which respective pins 123sp1, 123sp2 extend. Similar to FIG. 5a there are provided locking members 123sl1, 123sl2 to keep the pins 123sp1, 123sp1 in place.

FIG. 6b shows the splitable rope connector 123s-3 of FIG. 6a after having been spooled onto the auxiliary winch 122. The figure schematically but clearly illustrates how the pivoting feature of the rope connector 123s-3 facilitates spooling around the auxiliary winch 122, particularly when the rope connector 123s-3 is relatively large compared to the winch 122. In fact, this rope connector 123s-3 provides for a better spooling. In addition, the more symmetric design is advantageous for hoisting as it tolerates heavier loads. Disconnecting the connector parts 123s1, 123s2 in this embodiment requires the removal of at least one of the respective pins 123sp1, 123sp2.

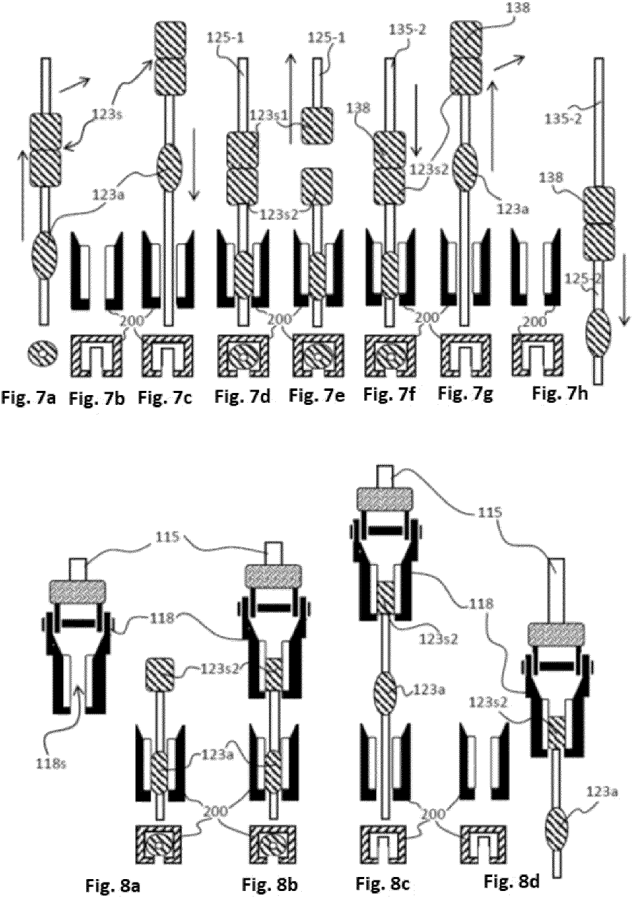

FIGS. 7a-7g illustrate the interaction between the auxiliary rope connector 123a and the hang-off point 200 as well as how the connector parts 123s1, 123s2 of the splitable rope connector 123s can be disconnected and subsequently connected with a first type of end connector 138. The figures each show both front view as well as top view. In the stage shown in FIG. 7a, the rope assembly is moved towards the hang-off point 200 as illustrated by the arrows.

In the stage shown in FIG. 7b, the rope assembly is lowered from a position above the hang-off point 200, wherein the auxiliary rope connector 123a approaches the hang-off point 200.

In the stage shown in FIG. 7c, the auxiliary rope connector 123a has landed in the hang-off point 200.

In the stage shown in FIG. 7d, the first connector part 123s1 is disconnected from the second connector part 123s2 and the first section 125-1 of the auxiliary rope 125 is pulled up and away.

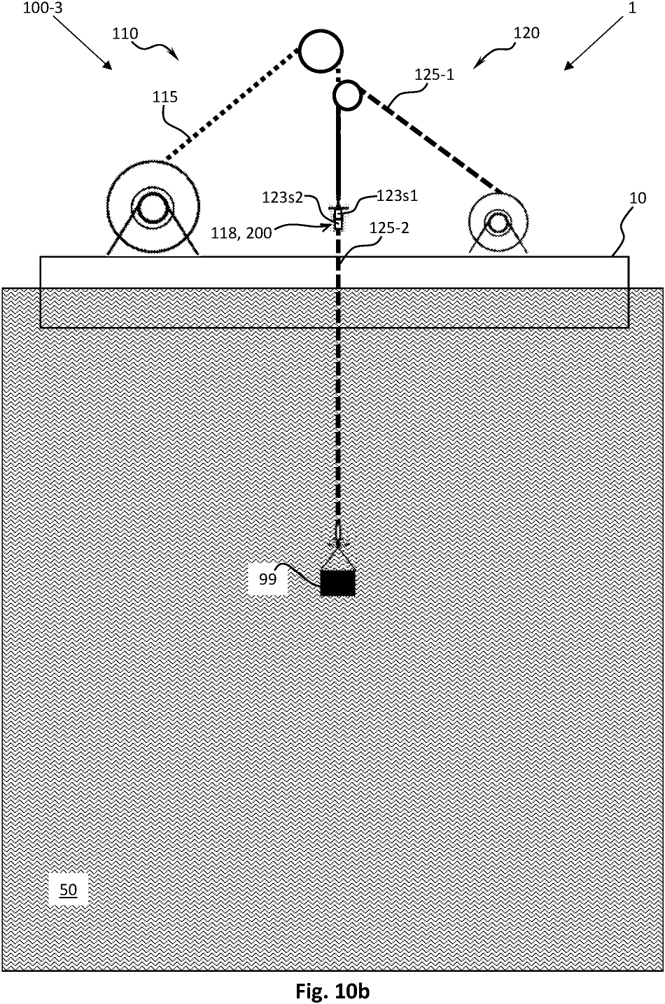

In the stage shown in FIG. 7e, a further second section 135-2 of a further auxiliary rope 135 (FIG. 9) is lowered having a further end connector 138 mounted at its end. The further end connector 138 is subsequently connected to the second connector part 123s2.

In the stage shown in FIG. 7f, the rope assembly is lifted up freeing the auxiliary rope connector 123a from the hang-off point 200.

In the stage shown in FIG. 7g, the rope assembly is moved away from the hang-off point 200.

As an alternative to using a further auxiliary winch system with a further auxiliary rope 135 (as will be explained with reference to FIG. 9) it is also possible to modify the main winch system of FIGS. 2a-2h by replacing the end connector 118 with the end connector as presented in FIGS. 7e-7g. The advantage of this type of end connector is that it renders it easier to connect multiple auxiliary winches in series as will be discussed with reference to FIG. 9.

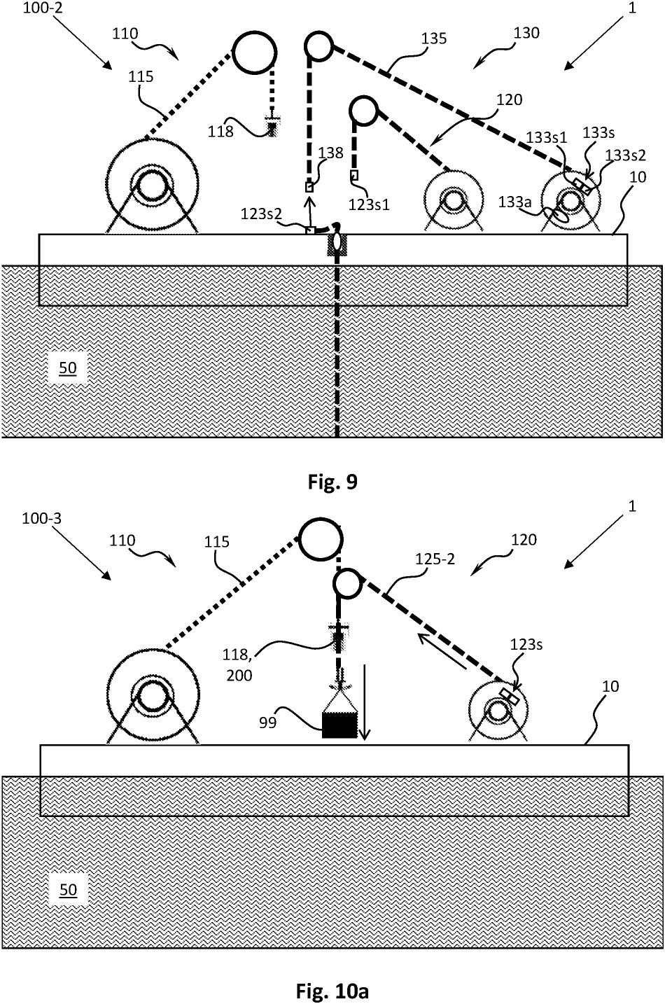

FIGS. 8a-8d illustrate the interaction between the auxiliary rope connector 123a and the hang-off point 200, as well as how the connector parts 123s1, 123s2 of the splitable rope connector 123s can be disconnected and subsequently connected with a second type of end connector 118 similar to FIGS. 2a-2h. The figures each show both front view as well as top view. This other type of end connector 118 comprises a receiving space 118s that is configured and shaped for receiving the second connector part 123s2. In FIG. 8a, the end connector 118 is moved towards the second connector part 123s2. In FIG. 8b, the second connector part 123s2 is suspended from the end connector 118. In FIG. 8c, the rope assembly is lifted such that the auxiliary rope connector 123a is freed from the hang-off point 200. In FIG. 8d the rope assembly is moved away from the hang-off point 200.

FIG. 9 shows another embodiment of a method of hoisting a load 99 in accordance with the principles described herein and using another embodiment of the hoisting system 100-2 in accordance with the principles described herein. This embodiment will be mainly discussed in as far as it differs from the previously discussed embodiments. In this embodiment the same “trick” is in fact repeated. The figure complies with the stage shown in FIG. 2d. However, instead of connecting the main winch system 110 to the second connector part 123s2, a further auxiliary winch system 130 is provided. This system has been drawn larger than the other auxiliary winch system 120, however, that is purely for facilitating the drawing. The further auxiliary winch system 130 may be similar to the auxiliary winch system 120. It may comprise a further auxiliary rope 135 similar to the earlier-discussed auxiliary rope 125. It also may comprise a further auxiliary rope connector 133a similar to the earlier-discussed auxiliary rope connector 123a and a further splitable rope connector 133s similar to the earlier-discussed splitable rope connector 123, wherein the further splitable rope connector 133s comprises respective further connector parts 133s1, 133s2 similar to the earlier-discussed connector parts 123s1, 123s2. After connecting the further end connector 138 to the second connector part 135s2, the same steps are to be done as for the first auxiliary winch system. Finally, the main winch system 110 can be connected as previously discussed.

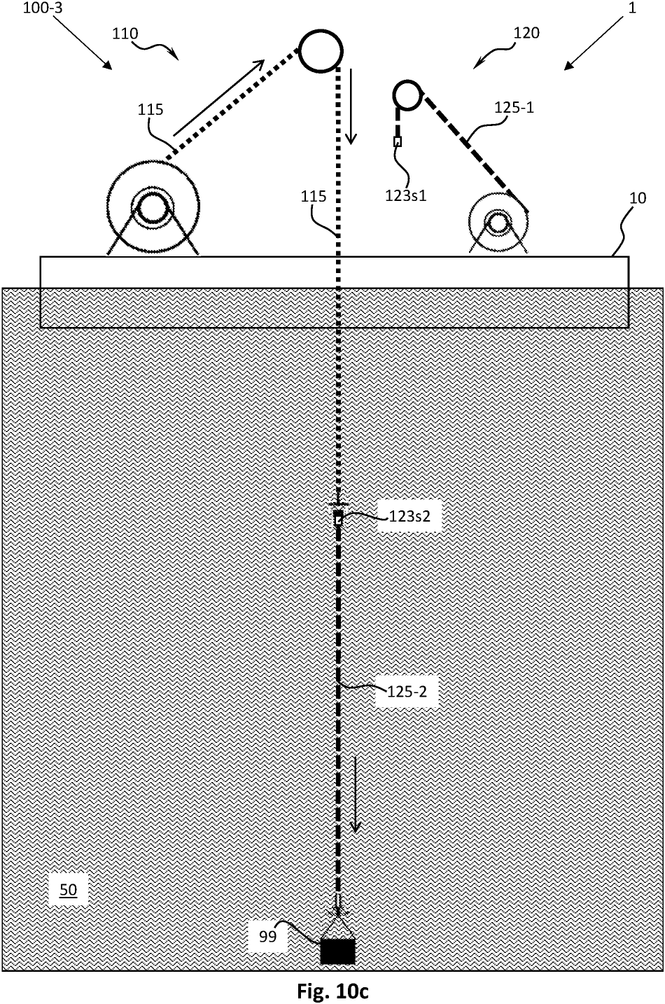

FIGS. 10a-10c show different stages of yet another embodiment of a method of hoisting a load 99 in accordance with the principles described herein and using yet another embodiment of the hoisting system 100-3 in accordance with the principles described herein. This embodiment will be mainly discussed in as far as it differs from the previously discussed embodiments. The stage of this method complies with the stage in FIG. 2b. The main difference between this embodiment and that of FIG. 2b is that the hang-off point 200 is now integrated into the end connector 118 of the main winch. Further, the auxiliary rope connector is left out because it is no longer needed.

In the stage shown in FIG. 10a, the second section 125-2 of the auxiliary rope 125 is guided through the end connector 118 with hang-off functionality, while the load 99 is lowered. In an alternative embodiment, using a 3-pod connector made of spliced ropes, one may also connect the main winch system 110 and the auxiliary winch system 120 to the same load and disconnect the auxiliary winch system 120 when the load is transferred to the main winch system 110. This can also be a safe operation on deck.

In the stage shown in FIG. 10b, the load 99 is lowered so much that the splitable rope connector 123s has landed in the hang-off point 200 in the end connector 118. At this stage, the two connector parts 123s1, 123s2 can be disconnected and the auxiliary winch 120 can be moved away.

In the stage shown in FIG. 10c, the load 99 is further lowered using the main winch system 110 and the main rope 115.

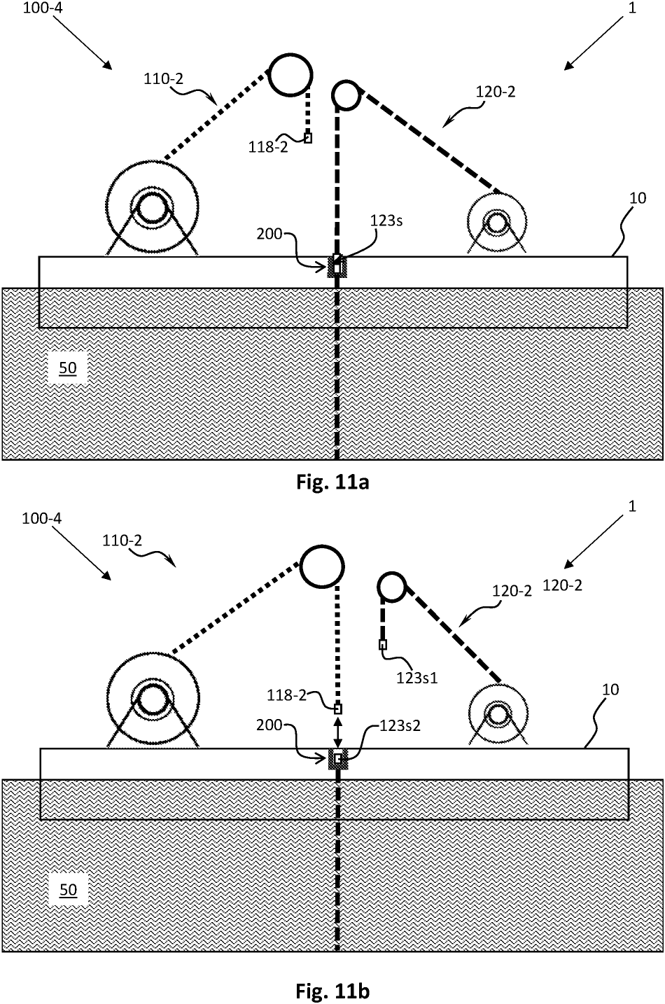

FIGS. 11a-11b show different stages of yet another embodiment of a method of hoisting a load 99 in accordance with the principles described herein and using yet another embodiment of the hoisting system 100-4 in accordance with the principles described herein. This embodiment will be mainly discussed in as far as it differs from the previously discussed embodiments. The main difference resides in a modified main winch system 110-2, which has a modified end connector 118-2 similar to the end connector 138 of the further auxiliary winch system 130 as illustrated in FIG. 9. A further difference is that the auxiliary winch system 120-2 is also modified by removing the auxiliary rope connector.

The stage shown in FIG. 11a complies with the stage of FIG. 2c but then without the auxiliary rope connector 123a. The splitable rope connector 123s has landed in the hang-off point 200.

In the stage shown in FIG. 11b, the modified end connector 118-2 of the modified main winch system 110-2 is lowered towards the second connector part 123s2 such that it can be connected. The method can be subsequently continued similar to what is shown in FIG. 2e.

For all embodiments of winch systems described herein, the following practical characteristics may apply:
Main winch system 110: steel wire rope or fibre rope with a length between 1000 m and 6000 m;
Auxiliary winch system 120: fibre rope or steel wire rope with a length between 1000 m and 6000 m, the first section with a length between 100 m and 300 m, and the second section with a length between 1000 m and 6000 m; and
Further auxiliary winch system 130: fibre rope or steel wire rope with a length between 1000 m and 6000 m, the first section with a length between 100 m and 300 m, and the second section with a length between 1000 m and 6000 m.

As an alternative to the connectors and connector parts shown in this description, embodiments described herein may be also using shackles, hooks, and tripods. This works equally well.

The particular embodiments disclosed above are illustrative only, as the invention may be modified and practiced in different but equivalent manners apparent to those skilled in the art having the benefit of the teachings herein. The invention may be applied in various hoisting applications, particularly but not limited to subsea hoisting application, for example onshore mining operations.

Embodiments described herein cover all these variants as long as they are covered by the independent claims. No limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage. The invention may be implemented by means of hardware comprising several distinct elements, and by means of a suitably programmed computer. In the device claims enumerating several means, several of these means may be embodied by one and the same item of hardware.

What is claimed is:

1. A hoisting system for hoisting a load, the hoisting system comprising:
a main winch system including a main rope with an end connector mounted to an end of the main rope, wherein the main winch system is configured to both spool the main rope in and spool the main rope out;
an auxiliary winch system including an auxiliary rope having at least one rope connector of which at least one is a splitable rope connector, wherein the auxiliary rope comprises a first section and a second section connected to the first section with the splitable rope connector, wherein the second section is configured to be spooled out before the second section when the auxiliary winch system is spooled out, wherein the splitable rope connector comprises at least two connector parts that are releasably connected with each other for allowing quick disconnection and reconnection between the second section and the first section, wherein the connector parts are configured to releasably connect with the end connector of the main rope, wherein the auxiliary winch system is configured to both spool the auxiliary rope in and spool the auxiliary rope out while the load is being suspended from an end connector of the auxiliary rope, and
a hang-off point positioned and configured to temporarily hold a respective rope connector of the auxiliary rope for transferring the load to the hang-off point.

2. The hoisting system of claim 1, wherein the hang-off point is mounted at a fixed-point external to the winches.

3. The hoisting system of claim 1, wherein the hang-off point is embodied in the end connector of the main rope.

4. The hoisting system of claim 2, wherein the hang-off point is configured to move between a first position for engagement with the at least one rope connector and a second position not engaging with the at least one rope connector.

5. The hoisting system of claim 1, wherein the hang-off point includes at least two modes including an engagement mode with the at least one rope connector blocked from passing through the hang-off point and a releasing mode with the at least one rope connector allowed to pass through the hang-off point.

6. The hoisting system of claim 1, wherein the second section of the auxiliary rope comprises at least one auxiliary connector configured to connect to the hang-off point (200) while the connector parts of the splitable rope connector are disconnected or reconnected.

7. The hoisting system of claim 1, wherein the auxiliary winch system comprises a first compartment configured to receive the second section and a second compartment configured to receive the at least one rope connector and the first section .

8. The hoisting system of claim 6, wherein the second section of the auxiliary rope comprises a plurality of rope connectors along its length.

9. The hoisting system of claim 1, further comprising:
a further auxiliary winch system including a further auxiliary rope having a further end connector mounted to an end of the further auxiliary rope and at least one further connector of which at least one is a further splitable rope connector, wherein the further auxiliary rope comprises a further first section and a further second section connected to the further first section with the further splitable rope connector, wherein the further second section is configured to be spooled out first when the further auxiliary winch system is spooled out, wherein the further splitable rope connector comprises at least two further connector parts that are releasably connected with each other for allowing quick disconnection and reconnection between the further second section and the further first section, wherein the further auxiliary winch system is configured to both spool the further auxiliary rope in and spool the further auxiliary rope out while the load is being suspended from an end connector of the further auxiliary rope.

10. A method for hoisting a load using the hoisting system of claim 1.

11. The method of claim 10, further comprising:
suspending the auxiliary rope from the hang-off point by connecting a respective one of the at least one rope connector of the auxiliary rope with the hang-off point thereby releasing the splitable rope connector for handling, and
disconnecting the first section and the second section of the auxiliary rope by disconnecting the connector parts and connecting the end connector of the main rope to the connector part of the second section, or disconnecting the end connector of the main rope from the connector part of the second section and reconnecting the first section and the second section of the auxiliary rope by reconnecting the connector parts.

12. The method of claim 11, further comprising:
suspending the load from the auxiliary rope;
hoisting down the load using the auxiliary winch system spooling out the auxiliary rope;
suspending the auxiliary rope from the hang-off point by connecting a respective one of the at least one rope connector of the auxiliary rope with the hang-off point thereby releasing the splitable rope connector for handling;
disconnecting the second section from the first section by disconnecting the connector parts of the splitable rope connector;
connecting the connector part that is connected to the second section to the end connector of the main rope, and
hoisting down the load using the main winch system spooling out the main rope.

13. The method of claim 11, further comprising:
suspending the load from the auxiliary rope that is connected to the main rope:
hoisting up the load using the main winch system spooling in the main rope;
suspending the auxiliary rope from the hang-off point by connecting a respective one of the at least one rope connector of the auxiliary rope with the hang-off point thereby releasing the splitable rope connector for handling;
disconnecting the main rope from the auxiliary rope by disconnecting the end connector of the main rope from the connector part that is connected to the second section;
connecting the connector part that is connected to the first section to the connector part connected to the second section, and
hoisting up the load using the auxiliary winch system spooling in the auxiliary rope.

14. The method of claim 11, further comprising:
suspending the load from the auxiliary rope;
hoisting down the load using the auxiliary winch system spooling out the auxiliary rope;
suspending the auxiliary rope from the hang-off point by connecting a respective one of the at least one rope connector of the auxiliary rope with the hang-off point thereby releasing the splitable rope connector for handling;
disconnecting the second section from the first section by disconnecting the connector parts of the splitable rope connector;
connecting the connector part that is connected to the second section to the further end connector of the further auxiliary rope;
hoisting down the load using the further auxiliary winch system spooling out the further auxiliary rope;
suspending the further auxiliary rope from the hang-off point by connecting a respective one of the at least one further connector of the further auxiliary rope with the hang-off point thereby releasing the further splitable rope connector for handling;
disconnecting the further second section from the further first section by disconnecting the further connector parts of the further splitable rope connector;
connecting the further connector part that is connected to the further second section to the end connector of the main rope, and
hoisting down the load using the main winch system spooling out the main rope.

15. The method of claim 11, further comprising:
suspending the load from the auxiliary rope that is connected to the main rope via the further auxiliary rope;
hoisting up the load using the main winch system spooling in the main rope;
suspending the further auxiliary rope from the hang-off point by connecting a respective one of the at least one further connector of the further auxiliary rope with the hang-off point thereby releasing the further splitable rope connector for handling;
disconnecting the main rope from the further auxiliary rope by disconnecting the end connector of the main rope from the further connector part that is connected to the further second section;
connecting the further connector part that is connected to the further first section to the further connector part connected to the further second section, and
hoisting up the load using the further auxiliary winch system spooling in the further auxiliary rope;
suspending the auxiliary rope from the hang-off point by connecting a respective one of the at least one rope connector of the auxiliary rope with the hang-off point thereby releasing the splitable rope connector for handling;
disconnecting the further auxiliary rope from the auxiliary rope by disconnecting the further end connector of the further auxiliary rope from the connector part that is connected to the second section;
connecting the connector part that is connected to the first section to the connector part connected to the second section, and
hoisting up the load using the auxiliary winch system spooling in the auxiliary rope.
